(19) United States
(12) Patent Application Publication
(10) Pub. No.: US 2008/0107119 A1
(43) Pub. Date: May 8, 2008

(54) Method and system for guaranteeing QoS between different radio networks

(75) Inventors: Kai-Hsiu Chen, Changhua County (TW); Jui-Hung Yeh, Taipei City (TW); Jyh-Cheng Chen, Hsinchu City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/797,612

(22) Filed: May 4, 2007

(30) Foreign Application Priority Data
Nov. 8, 2006 (TW) 95141279

(51) Int. Cl. H04L 12/28

(52) U.S. Cl. 370/395.21

(57) ABSTRACT

A method and system for guaranteeing QoS between different radio networks is disclosed. The radio networks comprise a first network and a second network. The first network, operating in Diff-serv mode, comprises a user equipment (UE). The second network comprises an AAA server, a TTG, and a GGSN. In the method a request to the TTG is initialized by the UE. A first QoS parameter is mapped to an IP header by the UE, an authentication request is then sent to the AAA server. The first QoS parameter is mapped to a second QoS parameter, and a Create PDP context request is constructed with the second QoS parameter to the GGSN to request a PDP context and a GTP-U tunnel.

### BACKGROUND OF THE INVENTION

### Field of the Invention

The invention relates to wireless communication, and more particularly, to a method and system for integrating and quality of service (QoS) between different wireless networks.

The IEEE 802.11 Wireless Local Area Network (WLAN) standard, introduced in 1997, has experienced rapid development due to its low implementation cost and wide frequency range. Three standards, IEEE 802.11a, b, and g, provide transmission rates from 11 Mbps to 54 Mbps.

The maximum WLAN transmission distance is approximately 100 meters. WLAN transmission quality is vulnerable changes in terrain and other environmental variables. WLAN also shares frequency bands with industrial, scientific and the medical products, thus, WLAN communication quality is affected by electronic devices.

Unlike WLAN, third generation (3G) mobile communication systems only provide a transmission rate of up to 384 Kbps. The 3G service range is, however, effective for several kilometers. Moreover, because 3G communication systems make use of a dedicated frequency band, 3G offers more stable communication quality. Two standards, the Third Generation Partnership Project (3GPP), the Third Generation Partnership Project 2 (3GPP2), are the current leading 3G mobile communication systems.

Due to the rapid growth of development of the 3G communication system and WLAN, it is predicted that the next generation Internet network will continue to utilize the Internet Protocol (IP). The integration of the 3G communication system and WLAN is thus a foreseeable trend.

To this end, an integration standard is under development by the 3GPP. FIG. 1 shows an integrated WLAN/3GPP structure. User equipment (UE) must first be authenticated, using the subscriber identity module or the universal subscriber identity module (SIM/USIM), by an authentication authorization accounting server (AAA Server). Subsequent to authentication, the UE can access nodes such as a WLAN access gateway (WAG) or a packet data gateway (PDG) through WLAN to connect with the WLAN/3GPP IP Access Network.

Prior to a UE accessing a 3GPP network, however, a PDP context must be constructed. Additionally, prior to a UE returning from the 3GPP network to a WLAN, another PDP context also must be constructed, and the Network (Layer) Service Access Point Identifier (NSAPI) must be the same as the one of the original PDP context.

Integrated WLAN/3GPP structures promise seamless roaming, which allows users to have non-stop service with some service quality. Based on the integrated WLAN/3GPP structures presented by the 3GPP, a WLAN UE must make a connection and set some parameters prior to logging on to the 3GPP network. The number of parameters required to access the 3GPP network is greater than the number of parameters required to access a WLAN. Additionally, the parameters are not exactly the same, thus, when WLAN UE roams in a 3GPP network, a large number of parameters must be configured. Because configuring additional parameters slows access time, the structure of FIG. 1 leaves room for improvement. A similar problem is encountered when a UE roams from the 3GPP network to a WLAN; the problem, however, is less severe.

### BRIEF SUMMARY OF THE INVENTION

Accordingly, the invention provides a method and system for guaranteeing quality of service (QoS) between two different radio networks with minimum modification of the WLAN/3GPP structures.

In one aspect of the invention, a method for guaranteeing QoS between different radio networks is provided. The radio networks include a first and a second network. The first network comprises user equipment (UE) supporting the Differentiated Service (DiffServ). The second network comprises an authentication server, a gateway (for example a Tunnel Termination Gateway, TTG, but not limited to this) and a node. The method comprises the UE requesting a first QoS, and mapping a first QoS parameter to a header compliant to both the first network and the second network. The first QoS parameter of the header is then mapped to a second QoS level of the second network by the gateway, wherein the second QoS parameter is associated with the second QoS level. A QoS request is constructed according to the second QoS parameter by the gateway. The second QoS parameter is transmitted to the node for requesting a QoS interconnection between the first and the second networks. The node determines whether to accept the second QoS level according to a QoS management. The gateway is informed whether the QoS interconnection has been constructed.

In another aspect of the invention, a system for guaranteeing QoS between different radio networks provided. The system comprises a first network and a second network. The first network comprises user equipment (UE) for requesting a first QoS, and maps a first QoS parameter to a header compliant with both the first network and the second network. The second network comprises a gateway (for example a Tunnel Termination Gateway (TTG), but not limited to this) and a node. The TTG maps the first QoS parameter of the header into a second QoS level of the second network, constructs a QoS request according to the second QoS parameter, and requests that a QoS interconnection be constructed between the first and the second networks wherein the second QoS parameter is associated with the second QoS level. The node receives the second QoS parameter and the request for the QoS interconnection, determines whether to accept the second QoS level according to a QoS management, and informs the gateway whether the QoS interconnection has been constructed.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the invention.

FIG. 1 shows an integrated WLAN/3GPP network architecture;

FIG. 2 lists four classes of traffic and their required performance as defined by 3GPP systems;

FIG. 3 shows a block diagram of an embodiment of an integrated WLAN/3GPP network according to the invention. Note that, in 3GPP, PDG can be implemented to comprise TTG and GGSN;

FIG. 4 shows an exemplary embodiment of an edge router;

FIG. 5 shows a format of the Differentiated service (DiffServ) field; and

FIGS. 6a and 6b show a flowchart of how WALAN user equipment (UE) negotiates with a tunnel termination gateway of a 3GPP system.

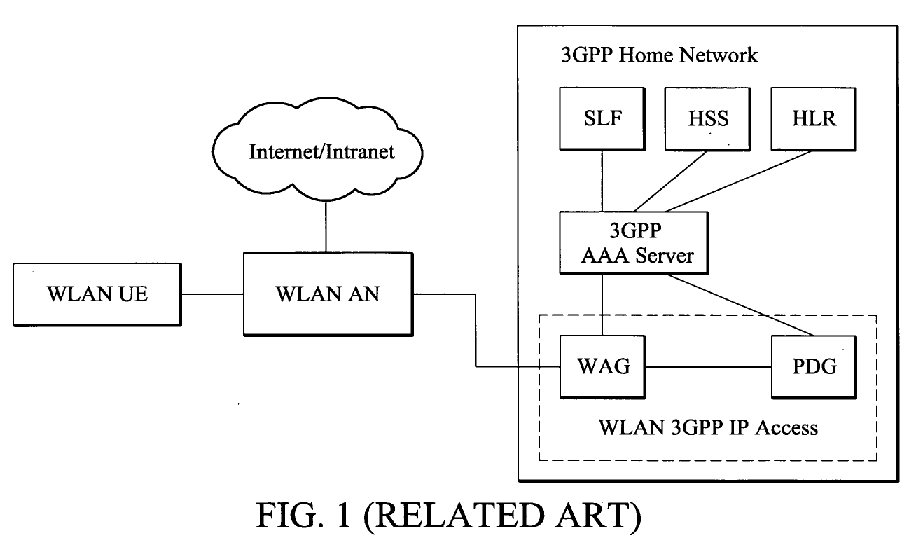

### DETAILED DESCRIPTION OF THE INVENTION

Prior to describing embodiments of the invention, description of 3GPP networks and WLAN are provided to further illustrate the scope of the invention.

After UEs connect to 3GPP networks, an IP Multimedia Subsystem (IMS) takes over further processing. When a UE is switched on, the IMS initializes a PDP Context Activation. The UE then obtains an IP address representing its location. The UE can be regarded as a node in the IP domain. After the UE obtains the IP address, the UE uploads the registration information (such as current address, current occupied resources) to the AAA server of the home network.

An IP Multimedia Subsystem (IMS) of the 3GPP Internet Protocol (IP) comprises a Call Session Control Function (CSCF). The CSCF manages call sessions. In addition to constructing and ending call sessions, the CSCF also provides real-time value-added services. For example, after a UE obtains the IP address, the UE must register with the Home Subscriber Server (HSS) of the home network for uploading registration information such as current IP address, current occupied network resources. The registration process is completed in conjunction with the CSCF. The CSCF obtains a user profile during the registration process, determines which services the user subscribed to, and exchanges the obtained information with an Application Server. Thus, the user can access services provided by the Application Server. A CSCF comprises 3 control devices, which are Proxy CSCF (P-CSCF), Interrogating CSCF (I-CSCF), and Serving CSCF (S-CSCF). The P-CSCF, the first contact point when a 3GPP UE enters the IMS, is responsible for designating UE requirements, such as registration, calls, value added services, and managing service quality.

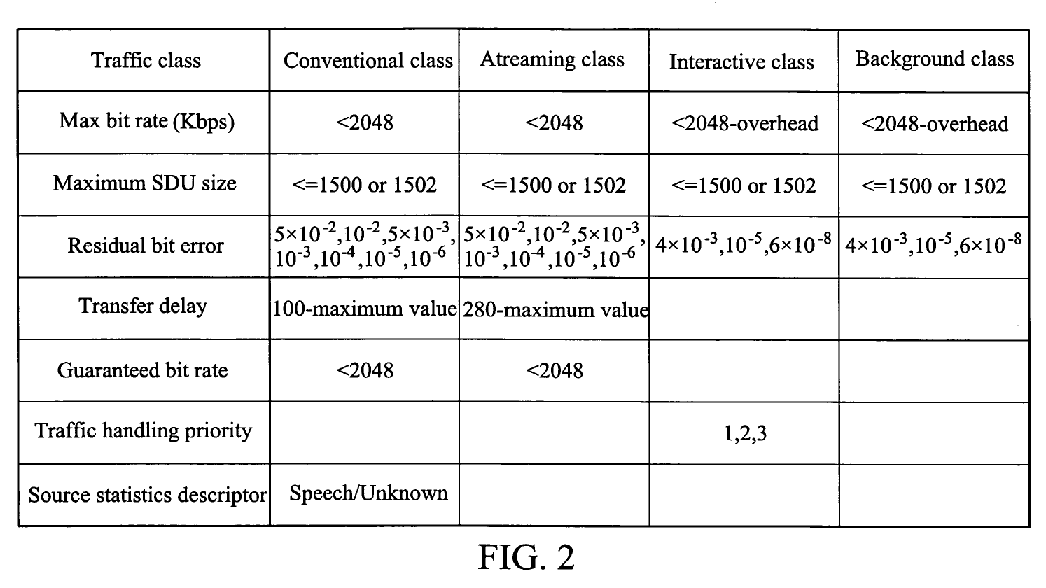

3GPP provides two services, real-time service and non-real-time service. The real-time is further divided into conversational service and streaming service, each of which has a different delay tolerance. The conversational service, such as phone calls, VoIP and video conferencing, has the most strict delay tolerance. The streaming service, such as on-line video streaming, is a one-way transmission. The delay during streaming services can be compensated by buffering transmission data. The non-real-time service is also divided into two classes, interactive service and background service. The interactive service, such as web browsing and data searching, is completed by users interacting with network servers. The background service, such as E-mail, massage transmission has a lower delay requirement. FIG. 2 shows parameters of the 4 services defined by 3GPP.

The Internet network provides two kinds of quality of service (QoS): Integrated service (IntServ) and differentiated service (DiffServ). Proposed earlier than DiffServ, the IntServ provides QoS for every requesting flow, and routers must preserve resources for each flow. Thus, routers must retain the status of each flow. The flows are sequential IP (Internet Protocol) packets from the same source, having the same destination, the same TCP/UDP port number and the same protocol. In IntServ, each flow requests a certain QoS comprising minimum transmission rate, maximum transmission delay, and packet loss rate. The entire Internet network determines whether to grant the requests based on current bandwidth. The DiffServ model is designed to solve the problem of IntServ, which is overloaded when too many flows are present in the routers. In the DiffServ model, the flows are processed by traffic aggregation rather than one-by-one. Aggregating traffic refers to collecting flows requesting similar QoS. Traffic is aggregated by classifying every packet entering an edge router (also known as a boundary router). A core router (also known as an interior router) then serves the flows with different QoS requests.

In some embodiments, the QoS is provided in the DiffServ model for WLAN and policy-based QoS management for 3GPP networks. Policy-based QoS, standardized by the Internet Engineering Task Force (IETF), is based on the concept of policy-based networking (PBN). In policy-based QoS, a service level agreement (SLA) describes QoS under different policies. Policies are rules for monitoring, distributing, managing and controlling internet resources. IETF has developed a Common Open Policy Service (COPS) as a protocol between Policy Decision Point (PDP) and Policy Enforcement Point (PEP) for interchanging policy information.

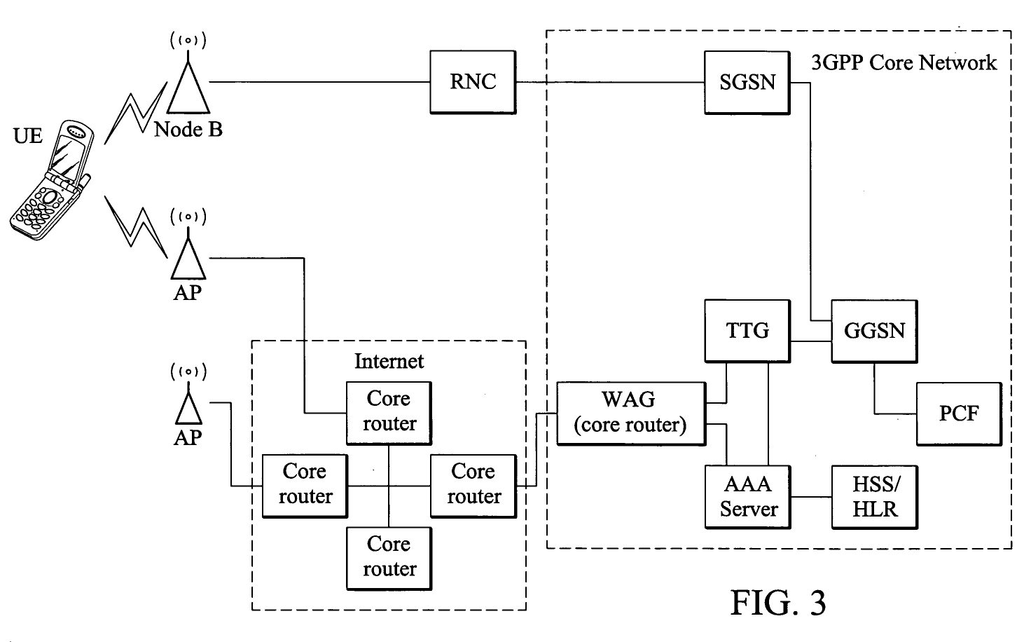

FIG. 3 shows an embodiment of an integrated WLAN/3GPP structure supporting QoS according to the invention. A gateway and a GGSN (Gateway GPRS Support Node) respectively functions as a PEP of a WLAN and a 3GPP network. All routers in the WLAN access network (WLAN AN) are set to DiffServ modes to act as core routers. The gateways are also edge routers for supporting the Diffserv QoS.

Note that the gateway disclosed in any exemplary embodiment of this invention can be TTG (Tunnel Terminal Gateway) but not limited to this, any other gateway also can be applied to this invention.

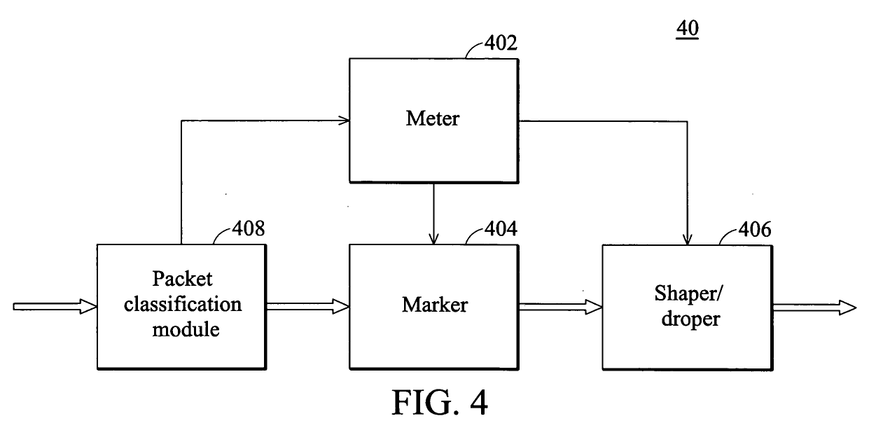

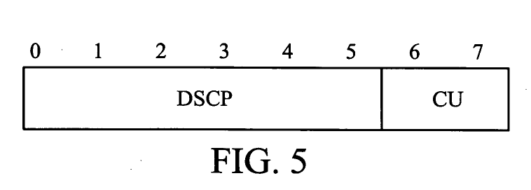

FIG. 4 shows an exemplary embodiment of an edge router according to the invention. An edge router performs packet classification and traffic conditioning. The packet classification is performed according to a service level specification (SLS). When a packet is sent to a DiffServ domain, the packet header is classified according to the content of the packet header. An edge router 40 comprises a meter 402, a marker 404, a shaper/dropper 406 and a packet classification module 408. The marker 404 sets the DS field (DiffServ field) of the IP header. The DS field defines basic rules of packet transmission in the DiftServ domain. The basic rules are also referred to as PHB (Per-Hop Behavior). The meter 402 is a counter supporting blocks 404-408. FIG. 5 shows a DS field in an IP header. The first six bits serve as the differential service codepoint (DSCP), where the DSCP defines each PHB and the procession of each packet in Differential Service. The last two bits are reserved, noted as currently unused (CU). In IPv4 packets, the DS field is located in the type of service (TOS) header. In IPv6 packets, the DS field is located in the Traffic Class byte. The shaper/dropper 406 controls the packet transmission rate by delaying or ignoring some packets. The marker 404 and shaper/dropper 406 function based on SLS.

After the DS field is set by the edge router, the packet is sent to a core router in a WLAN AN. The core router collects packets which have the same DSCP to form a behavior aggregate (BA) and jointly processes them.

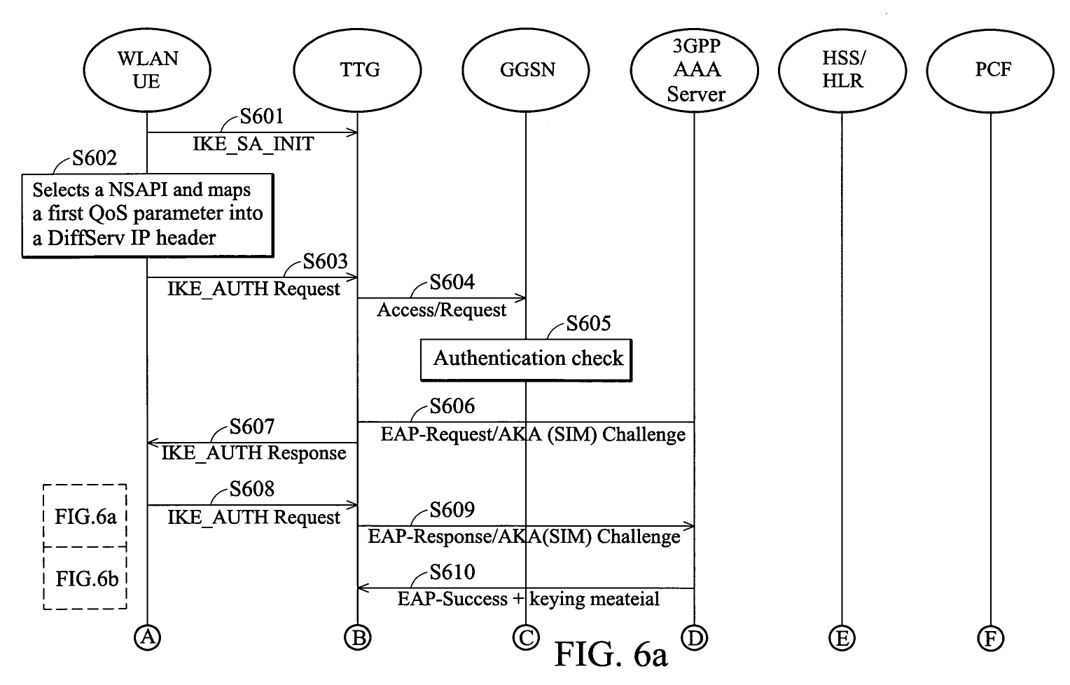

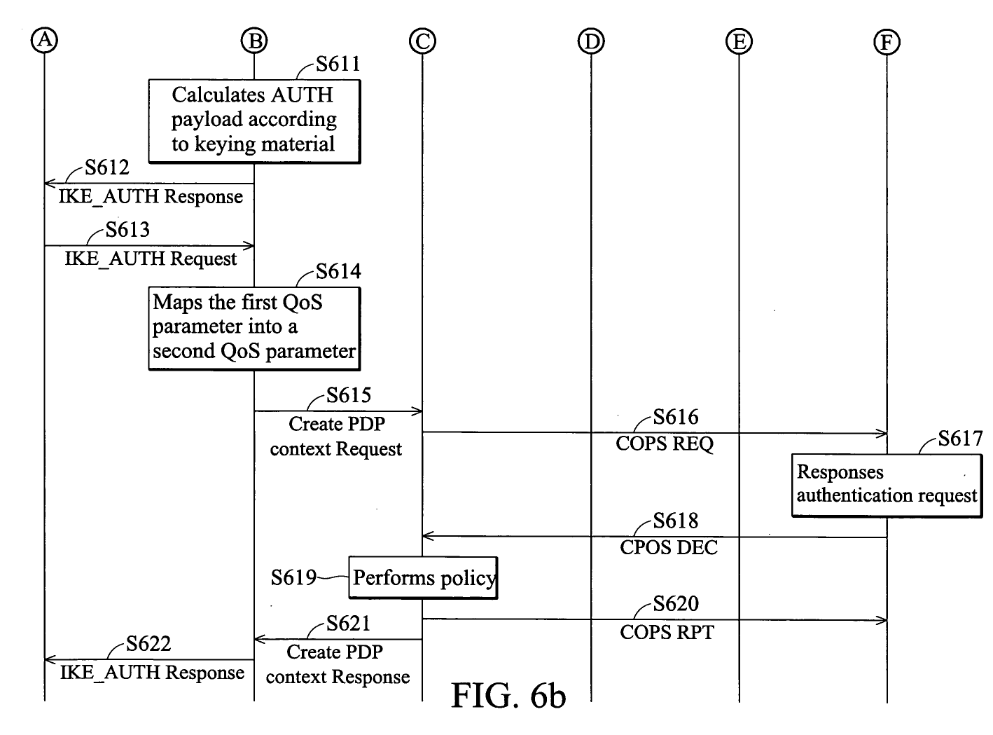

In the DiffServ domain, the QoS of each flow can be recognized by the packet header. Thus, in one embodiment of the invention, this characteristic is utilized to form a method of communicating with a TTG while the UE logs on to a WLAN. FIG. 6a and 6b show a flowchart of how a UE from a WLAN negotiates with a gateway of a 3GPP system. Here, the gateway is a TTG for example, but not limited to this. In step S601, a UE from a WLAN transmits a security initialization (IKE_SA_INIT) to a TTG of a PDG. In step S602, the UE selects a Network (Layer) Service Access Point Identifier (NSAPI) and maps a first QoS parameter, which is defined by Session Description Protocol (SDP), to a header according to a session characteristic. The header may be a Differentiated service (DiffServ) IP header. SDP is a protocol specifying the compression and coding schemes of multimedia (audio, video, etc.) information, as well as the transmission protocol (such as RTP/UDP/IP), and other similar data used in the session. A QoS mode is selected corresponding to the first QoS parameter, and is inserted into an IP header to inform the TTG of the session requirements. The TTG may further request a 3GPP core network for a QoS corresponding to the selected QoS mode. In one embodiment, the TTG uses a value presented in the type of service (TOS) to select a QoS mode from the 4 QoS modes. The selected QoS mode is then mapped to a second QoS level. The second QoS level is a QoS that a 3GPP core network can serve. In some embodiments, a minimum QoS level among all the QoS levels is mapped as the second QoS level. For example, in accordance with FIG. 2, when a TTG receives a packet with SDU size as large as 1518-bytes, a maximum SDU size as large as 1500 bytes is selected as the second QoS level. If the session is a conversational service, the SDU error rate is mapped to 10⁻², and the residual bit error ratio is mapped 5*10⁻², wherein 10⁻² and 5*10⁻² are the maximum SDU error rate and the maximum residual bit error ratio among all the SDU error rates and all the residual bit error ratios in conversional service. In steps S603-S604, the WLAN UE transmits a security authentication request IKE_AUTH Request to a 3GPP AAA server, via the TTG. Because the IKEv2 information is loaded in the IP/UDP, a first QoS parameter, representing the QoS mode, is inserted in the IP header. Steps S605-S613 are the authentication process specified by IKEv2. In step S614, because the authentication is successfully completed, the TTG maps the first QoS parameter into a second QoS parameter within a permissible range of 3GPP core networks. In step S615, based on the second QoS parameter, the TTG generates a Create PDP context Request for requesting a GGSN to construct a PDP Context and a GTP-U tunnel. Steps S616-S620 are the same as the 3GPP Policy-based IP QoS management. A policy control function (PCF) of P-CSCF determines whether the requested QoS can be performed. If the requested QoS is accepted, the QoS of the UE is managed by the GGSN. In step S621, TTG can determine if the PDP Context is successfully constructed according to the information contained in the Create PDP Context Response. Once the PDP Context is successfully constructed, the TTG functions as an edge router of a Differentiated service (DiffServ), thus the QoS of the UE can be served by the TTG.

Because steps S601, S603-S613 and S622 are substantially the same as the authentication process of IKEv2, the QoS can be served between different radio networks, without any amendment of original IKEv2 procedure and packet format.

Because a QoS profile can not be recognized at the time a UE attaches to a WLAN, an additional information exchange is required to construct a PDP Context. A QoS parameter is retained in the TOS field of an IP header, thus, both radio networks share the QoS information.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for guaranteeing quality of service (QoS) between different radio networks, wherein the radio networks comprises a first network and a second network, the first network comprises a user equipment (UE) that supports a differential service, the second network comprises a gateway and a node, and the method comprises:
requesting a first QoS by the UE, and mapping a first QoS parameter to a header compliant with both the first network and the second network;
mapping the first QoS parameter of the header into a second QoS level of the second network by the gateway;
constructing a QoS request according to a second QoS parameter by the gateway, wherein the second QoS parameter is associated with the second QoS level, transmitting the second QoS parameter to the node, and requesting that a guaranteed QoS interconnection be constructed between the first and the second networks;
according to a QoS management, determining whether to accept the second QoS level through the node;
informing the gateway, through the node, whether the QoS interconnection has been constructed.

2. The method for guaranteeing QoS between different radio networks as claimed in claim 1 further comprising transmitting a security initialization to the gateway through the UE prior to mapping the first quality parameter to the header.

3. The method for guaranteeing QoS between different radio networks as claimed in claim 2, wherein the security initialization further comprises a security authentication request, and the UE sends the security authentication request via the gateway to an authentication server.

4. The method for guaranteeing QoS between different radio networks as claimed in claim 1, wherein the QoS request is a PDP Context Request.

5. The method for guaranteeing QoS between different radio networks as claimed in claim 1, wherein the first QoS of the first network is served by a plurality of entering nodes of the second network once the node informs the gateway that the QoS interconnection has been constructed.

6. The method for guaranteeing QoS between different radio networks as claimed in claim 5, wherein the plurality of entering nodes of the second network are TTGs, GGSNs, PDGs, WAGs, or any other nodes located between entering nodes and nodes that handle packets of both the first and second networks.

7. The method for guaranteeing QoS between different radio networks as claimed in claim 1, wherein the first and the second QoS level are suit for every heterogeneous network with service QoS mapping table.

8. The method for guaranteeing QoS between different radio networks as claimed in claim 1, wherein the second network is a General Packet Radio Service (GPRS) network.

9. The method for guaranteeing QoS between different radio networks as claimed in claim 1, wherein the second network is a Universal Mobile Telecommunication System (UMTS).

10. The method for guaranteeing QoS between different radio networks as claimed in claim 9, wherein the second network further comprises an authentication server, and the authentication server is a 3GPP AAA server.

11. The method for guaranteeing QoS between different radio networks as claimed in claim 9, wherein the QoS management is a 3GPP Policy-based IP QoS management.

12. The method for guaranteeing QoS between different radio networks as claimed in claim 9, wherein the gateway is a tunnel termination gateway (TTG).

13. The method for guaranteeing QoS between different radio networks as claimed in claim 9, wherein the node is a GGSN, and the second network further comprises a Home Subscriber Server (HSS) and a Policy Control Function (PCF).

14. The method for guaranteeing QoS between different radio networks as claimed in claim 1, wherein the first network is a Wireless Local Area Network (WLAN).

15. The method for guaranteeing QoS between different radio networks as claimed in claim 14, wherein the header is Differentiated service (DiffServ) IP header, and the step of mapping the first QoS parameter of the header into a second QoS level of the second network further comprises:
selecting a Network (Layer) Service Access Point Identifier (NSAPI); and
mapping the first QoS parameter, which is defined by Session Description Protocol (SDP), to the header according to a session characteristic.

16. The method for guaranteeing QoS between different radio networks as claimed in claim 14 further comprising transmitting an initialization authentication to the TTG through the UE prior to mapping the first quality parameter to the header, wherein the initialization authentication is an IKE_SA_INIT.

17. The method for guaranteeing QoS between different radio networks as claimed in claim 16, wherein the security initialization further comprises a security authentication request, and the security authentication request is an IKE_AUTH Request.

18. A system for guaranteeing quality of service (QoS) between different radio networks comprising:
a first network comprising a user equipment (UE) for requesting a first QoS by the UE and mapping a first QoS parameter to a header compliant with the first network; and
a second network comprising:
a gateway for mapping the first QoS parameter of the header into a second QoS level of the second network, inserting a QoS request to a second QoS parameter, wherein the second QoS parameter is associated with the second QoS level, and requesting that a guaranteed QoS interconnection be constructed between the first and the second networks; and
a node receiving the second QoS parameter and the request of the guaranteed QoS interconnection, determining whether to accept the second QoS level according to a QoS management, and informing the gateway whether the guaranteed QoS interconnection has been constructed.

19. The system for guaranteeing QoS between different radio networks as claimed in claim 18, wherein the UE further transmits a security initialization through the gateway prior to mapping the first quality parameter to the header.

20. The system for guaranteeing QoS between different radio networks as claimed in claim 18, wherein the security initialization further comprises a security authentication request, and the UE sends the security authentication request via the gateway to an authentication server.

21. The system for guaranteeing QoS between different radio networks as claimed in claim 18, wherein the QoS request is a PDP Context Request.

22. The system for guaranteeing QoS between different radio networks as claimed in claim 18, wherein the second network comprises a plurality of entering nodes, once the node of the second network informs the gateway that QoS interconnection has been constructed, the first QoS of the first network is served by the plurality of entering nodes.

23. The system for guaranteeing QoS between different radio networks as claimed in claim 22, wherein the plurality of entering nodes of the second network are TTGs, GGSNs, PDGs, WAGs, or any other nodes located between entering nodes and nodes that handle packets of both the first and second networks.

24. The system for guaranteeing QoS between different radio networks as claimed in claim 18, wherein the first and the second QoS level are suit for every heterogeneous network with service QoS mapping table.

25. The system for guaranteeing QoS between different radio networks as claimed in claim 18, wherein the second network is a General Packet Radio Service (GPRS) network.

26. The system for guaranteeing QoS between different radio networks as claimed in claim 18, wherein the second network is a Universal Mobile Telecommunication System (UMTS).

27. The system for guaranteeing QoS between different radio networks as claimed in claim 26, wherein the authentication server is a 3GPP AAA server.

28. The system for guaranteeing QoS between different radio networks as claimed in claim 26, wherein the QoS management is 3GPP Policy-based IP QoS.

29. The method for guaranteeing QoS between different radio networks as claimed in claim 26, wherein the gateway is a tunnel termination gateway (TTG).

30. The system for guaranteeing QoS between different radio networks as claimed in claim 26, wherein the node is a GGSN, and the second network further comprises a Home Subscriber Server (HSS) and a Policy Control Function (PCF).

31. The system for guaranteeing QoS between different radio networks as claimed in claim 18, wherein the first network is a Wireless Local Area Network (WLAN).

32. The system for guaranteeing QoS between different radio networks as claimed in claim 31, wherein the header is Differentiated service (DiffServ) IP header, and the UE further selects a Network (Layer) Service Access Point Identifier (NSAPI) and maps the first QoS parameter, which is defined by Session Description Protocol (SDP), to the header according to a session characteristic instead of mapping the first QoS parameter of the header to the second QoS level.

33. The system for guaranteeing QoS between different radio networks as claimed in claim 31, wherein the initialization authentication is an IKE_SA_INIT.

34. The system for guaranteeing QoS between different radio networks as claimed in claim 31, wherein the security initialization further comprises a security authentication request, and the security authentication request is an IKE_AUTH request.
